(19) United States
(12) Patent Application Publication
(10) Pub. No.: US 2008/0250655 A1
(43) Pub. Date: Oct. 16, 2008

(54) Knife, knife blade, knife rack and two U-shaped handle forms each attached at one end to the blade

(76) Inventor: David Cook, Sherman, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/082,963

(22) Filed: Apr. 14, 2008

Related U.S. Application Data
(60) Provisional application No. 60/923,216, filed on Apr. 12, 2007.

(51) Int. Cl. B25G 1/00; A47F 7/00

(52) U.S. Cl. 30/340; 211/70.7

(57) ABSTRACT

A knife includes a blade, and a handle. The handle includes a first wire form that is substantially U-shaped and is attached at only one end of the first wire form to the blade, and also includes a second wire form that is attached at only one end of the second wire form to the blade. The first wire form and the second wire form are substantially parallel elements of the single handle.

### CROSS-REFERENCE TO RELATED APPLICATION

Priority is claimed to U.S. Provisional Application 60/923,216 which was filed on Apr. 12, 2007.

### FIELD OF THE INVENTION

The invention relates to the field of knives. More particularly, the present invention pertains to knives having wire handles.

### BACKGROUND OF THE INVENTION

Many kitchens include a knife block for storing knives, and this entails inserting a knife blade downward into the block. A typical knife block may include several knife holes of various different sizes, for storing knives having correspondingly sized blades.

Unfortunately, the knife holes in a knife block are difficult to keep clean. Germs or other harmful substances may accumulate in the knife holes, so that a clean knife will often become contaminated when it is inserted into the knife hole of the knife block for storage.

Alternatively, knives may be stored in drawers with other kitchen utensils. However, many people prefer the knives to be located more prominently and visibly in a kitchen, because knives are used so frequently. Putting knives in a drawer is less convenient than above-counter storage, and storage in drawers may also require some degree of fumbling in order to find the particular sized knife that is desired.

It is known to store knives by hanging them, instead of by using drawers or knife blocks. For example, Sakai (U.S. Pat. No. 5,450,670) discloses a knife equipped with a hook at the end of the handle, so that the knife may be attached to another object. However, merely attaching a hook at the end of a handle has drawbacks, because hanging knives using a peg or rack may cause the knives to dangle precariously, instead of being firmly stored in storage positions. Moreover, a knife with a hook at the end is inconvenient for handling, because the hook makes it more difficult to take hold of the knife and manipulate the knife. Of course, a detachable hook would not solve these problems, because the process of attaching and detaching the hook would be time-consuming.

It is known to design a wire knife handle that can be used for hanging the knife. One example of a knife with wire handle is Teller (U.S. Pat. No. 1,366,610). However, those prior art wire handles are typically attached to a blade at both ends of the wire handle. That closed shape of the wire handle limits the type of rack that can be used, and again present problems associate with dangling knives, instead of firmly positioned knives.

It is also known to store knives using a magnetic rack, such as the rack of Chien (U.S. Pat. No. 6,216,888). Magnetic storage systems are not very popular, even though they do have the advantage of being open to the air, and wall mounted. The main disadvantage is that they can leave marks on the blade, and it is also possible for a knife to be knocked loose.

### SUMMARY OF THE INVENTION

The present invention includes a knife handle having two substantially parallel wire forms, each of which is substantially shaped like an elongated “U”. The two parallel wire forms attach to opposite sides of the blade. Each of the parallel wire forms is attached to the blade at only one end of its elongated “U”. The portion of a wire form that is attached to the blade is swaged.

Attaching each of the wires at only one end of the “U” is more economical from a manufacturing perspective, and has other substantial advantages as well. For example, attaching each of the wires at only one end of the “U” avoids an obstruction between the spine and the cutting edge of the blade, thus allowing the blade to be used more fully. Additionally, attaching each of the wires at only one end of the “U” allows creation of a finger guard at the other (free) end of the “U”, by bending that distal end away from the opening of the “U”.

This handle provides a larger gripping area compared to traditional handles, for a greater sense of security and control. At the same time, this handle is flexible, since the two wire forms are not attached to each other, except via the blade. Therefore, this handle provides the user with ergonomic and safety benefits not available with traditional handles or with other wire handles.

The part of the handle that is riveted to the spine of the blade provides the user with an area against which the thumb may be braced when paring, thereby giving the user greater control and security. Compared to a traditional chef's knife, the part of the handle that is riveted to the spine of the blade also provides the user with a wider area for the palm to rest on when using the knife for chopping.

The wire handled knife of the present invention may be stored by hanging the knife by its handle, thereby enabling a counter top method of storage wherein the blade is visible, and exposed to the air. Compared to traditional knife blocks, this configuration makes it easier to identify individual knives, and is inherently more sanitary than keeping the blade in a narrow slot with no air circulation.

When hanging the knife from the handle, this U-shaped handle is placed onto a peg. A knife rack can be provided as part of this knife storage system, including pegs. When each knife is in its storage position, a blade guard may cover at least part of its blade, thereby preventing the blade from swinging or dangling. The knife slides partially behind the blade guard when it is being hung on the peg. Each of the pegs preferably is bent upward as it extends from the rack. This bending of the peg has several substantial advantages, in addition to aesthetics: for example, bending the pegs upward prevents the handle from slipping off the peg. Additionally, the upwardly bent part of the peg is preferably long enough so that the knife will be a sufficient distance upward to prevent substantial pressure against the blade guard (when the knife is removed); thus, the blade of the knife will not be accidentally bent or scraped by the blade guard during removal of the knife from the rack.

### BRIEF DESCRIPTION OF THE DRAWINGS

FIG. 1A shows a wire form according to an embodiment of the present invention, viewed from the top.

FIG. 1B shows a wire form according to an embodiment of the present invention, viewed from the side.

FIG. 1C shows a second wire form according to an embodiment of the present invention, viewed from the top. The side view of the second wire form is also shown by FIG. 1b.

FIG. 2 shows a blade according to an embodiment of the present invention.

FIG. 3A is a side view of an assembled knife according to an embodiment of the present invention, including the wire forms of FIG. 1a and 1c, and the blade of FIG. 2.

FIG. 3B is a top view of the assembled knife shown in FIG. 3A.

FIG. 4A illustrates a knife rack according to an embodiment of the present invention, as viewed from the side.

FIG. 4B illustrates the knife rack according to FIG. 4A, as viewed from the front.

### DETAILED DESCRIPTION OF AN EMBODIMENT OF THE INVENTION

In exemplary embodiments of the present invention, each knife blade is manufactured without a tang. Depending on blade size, each knife blade has either two or three holes in the spine to accept rivets that hold the handles to the blade. Small blades (e.g. for a paring, steak, utility, or boning knife) have two rivet holes. Large blades (e.g. for a slicer, bread, or chef's knife) have three rivet holes. The heel of each blade is manufactured with an 8 millimeter radius on the spine and the ricasso.

One particular exemplary embodiment of the present invention will now be described. The description of this embodiment is for illustrative purposes only, and does not limit the various other embodiments that fall within the scope of the claimed invention. This embodiment pertains to a chef's knife, and a person of ordinary skill will understand that the same basic principles apply, for example, to a paring knife, a boning knife, a utility knife, and various other types of knives. In this embodiment, the knife blade is made of stainless steel.

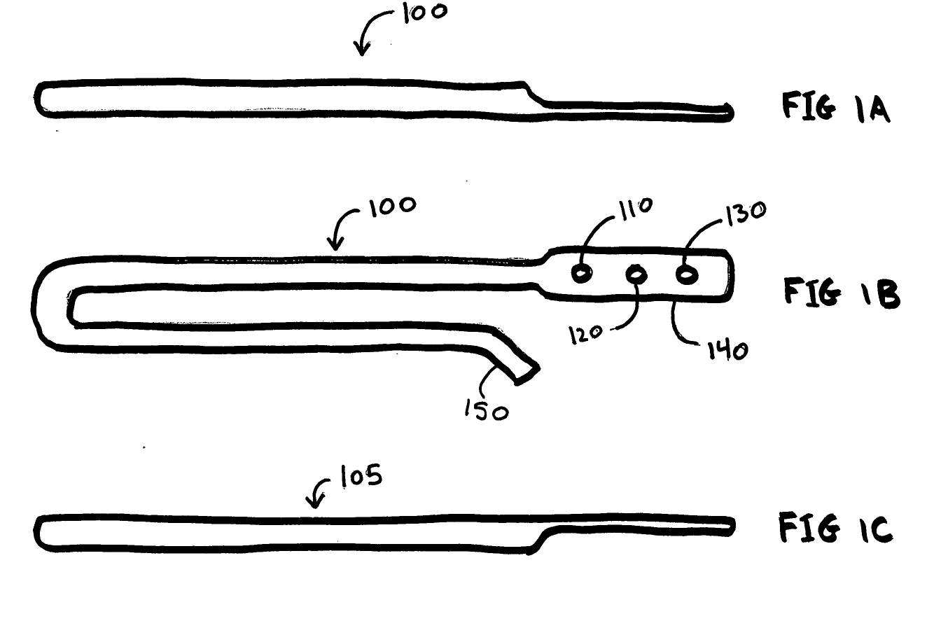

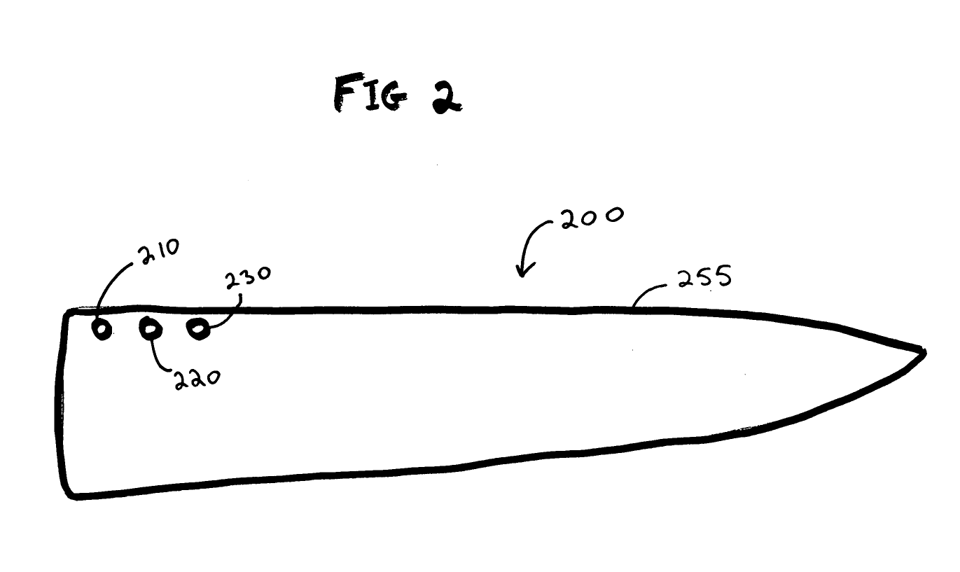

FIG. 1A is a top view of a wire form 100, and FIG. 1B is a side view thereof. FIG. 1C is a top view of a second wire form 105, and the second wire form has the same appearance from the side as was shown in FIG. 1B. The first wire form 100 has three rivet holes 110, 120, and 130 located at the swaged part 140 of the wire form. The second wire form 105 also has three rivet holes.

FIG. 2 is a side view of a knife blade 200. The blade has three rivet holes 210, 220, and 230.

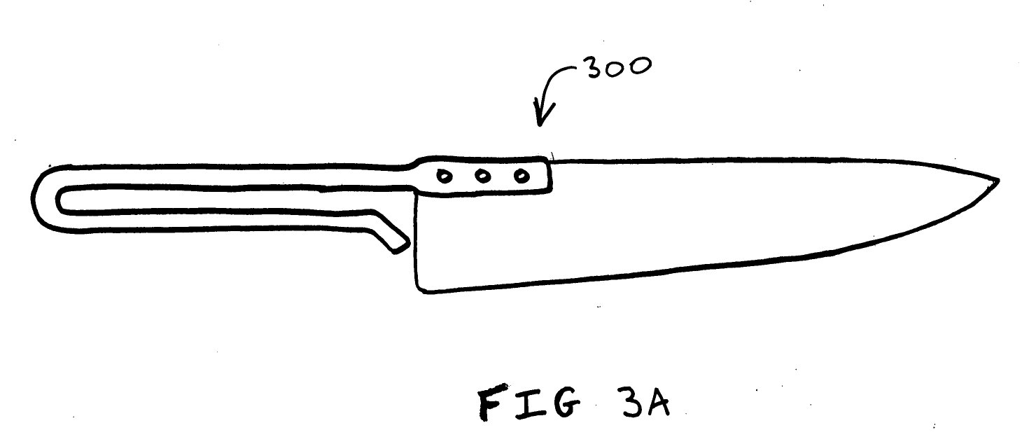

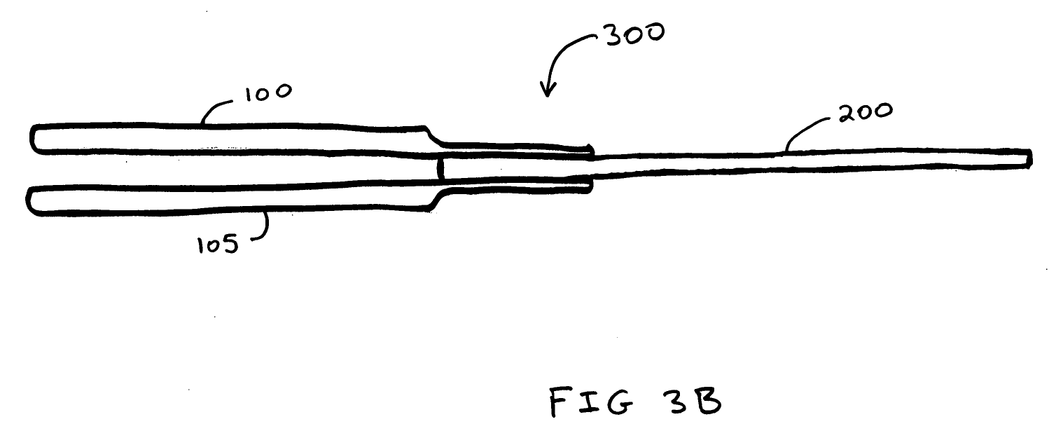

FIG. 3A shows the wire forms attached to the blade via the rivet holes, so as to form a complete knife 300. A top view of this knife is shown in FIG. 3B, including the blade 200, the first wire form 100, and the second wire form 105.

For the wire handles of the knife, the material is mild steel wire: 3/16″ (5 ml) diameter for the small handles, or ¼″ (6.5 mil) diameter for the large handles. As can be seen from the figures, each knife handle consists of a pair of wire forms, a left and right. Each wire form is in the shape of an elongated “U”. One end of the wire form is swaged, the other end is shaped to provide a finger guard 150. The swage is drilled to provide the holes for the rivets. The handles are coated with plastic.

Each knife consists of a pair of wire handle elements that are formed, swaged, drilled, coated, and riveted to a tangless blade. The tangless character of the blade allows the handle elements to attach directly to the main blade, in a flush position with respect to the spine 255 of the blade, thus giving the user a wide enough surface to press down on the blade with greater leverage than would have been possible if a tang had been used.

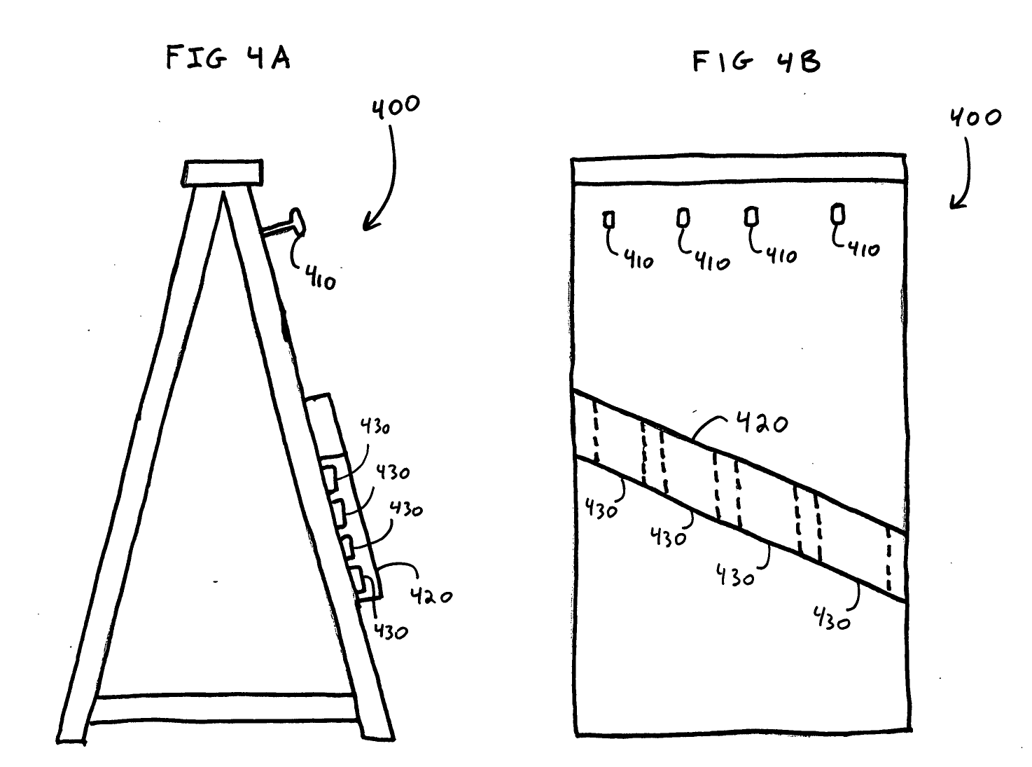

A standard knife block may be used to store these knives, and an alternative embodiment of the invention includes a storage rack consisting of a wooden “A-frame” 400 as shown in FIG. 4A from the side. In one embodiment of the rack, wire pegs 410 extend from the rack, knives are hung on the pegs, and a blade guard 420 positioned lower on the A-frame prevents the knives from swinging and dangling. The blade guard includes slots 430 for the knives. A front view of the rack is shown in FIG. 4B.

The invention includes an additional embodiment wherein the blade guard is hingedly attached to the rack, so that the blade guard can be unfastened and swung open. This facilitates cleaning of the side of the blade guard that ordinarily faces the rack.

The peg 410 may alternatively be bent upward at a 45 degree angle (i.e. pointing more than 45 degrees above horizontal). Thus, to remove a knife from the rack, the knife would have to be moved substantially in a direction having a component from the blade tip toward the peg, thus providing a further way to prevent unnecessary contact between the blade and the blade guard (which could otherwise occur if the knife were removed by simply pulling it away from the rack).

In a further embodiment, each peg may include a narrow stem and a wide head that is wider than the width of the knife handle's “U.” The narrow peg stem is narrow enough to fit between the blade and the finger guard (located at the free end of the handle's “U”). Thus, to remove a knife from the rack, the knife would have to be moved substantially in a direction from the blade tip toward the peg, and the peg stem would then have to pass between the blade and the finger guard, thus providing a further way to prevent unnecessary contact between the blade and the blade guard. This type of embodiment requires a U-shaped knife handle with only one end of the “U” attached to the blade.

Several concepts associated with the invention will now be briefly described. These brief descriptions are not meant to in any way limit what will ultimately be claimed in any application claiming priority hereto.

The invention includes a first concept which is a knife comprising a blade, a first wire form that is substantially U-shaped and is attached at only one end of the first wire form to the blade, and a second wire form attached at only one end of the second wire form to the blade, wherein the first wire form and the second wire form are substantially parallel elements of a single handle.

The invention also includes a second concept which is the knife of the first concept wherein the first wire form and the second wire form are unconnected except via the blade.

The invention also includes a third concept which is the knife of the first concept wherein the first wire form has a first swaged portion, and the second wire form has a second swaged portion, wherein the first swaged portion and the second swaged portion are configured to attach to the blade, and wherein the first wire form is shaped substantially identically to the second wire form, at least apart from the first swaged portion and the second swaged portion.

The invention also includes a fourth concept which is the knife of the first concept, wherein the blade is tangless, wherein the blade, the first wire form, and the second wire form include a plurality of holes arranged to attach the first wire form and the second wire form to the blade, and wherein the holes are arranged so that the first wire form and the second wire form each attach in a substantially flush position with respect to a spine of the blade.

The invention also includes a fifth concept which is a system comprising the knife of the first concept, and further comprising a rack configured to store at least said knife, the rack comprising an A-frame structure, at least one peg or other device configured to hold at least said knife against gravitational force, and a blade guard situated lower on the A-frame than the at least one peg or other device.

The invention also includes a sixth concept which is the system of the fifth concept, wherein the at least one peg or other device has a distal end that is bent upward, and wherein a portion of the distal end that is bent upwards has a length sufficient to prevent or inhibit the at least said knife from scraping against the blade guard.

The invention also includes a seventh concept which is the system of the fifth concept, further comprising a plurality of knives having different sizes, wherein said blade guard is arranged to secure at least part of each of said knives.

The invention also includes an eighth concept which is the system of the seventh concept, wherein said at least one peg are substantially arranged along a horizontal peg line, and wherein said blade guard is arranged in a slanted linear configuration, so that one end of the blade guard is closer to the horizontal peg line than another end of the blade guard.

The invention includes a ninth concept which is a wire form that is substantially U-shaped and comprises only one end configured to be attached to a knife blade, wherein the wire form has a swaged portion configured to attach to the blade.

The invention also includes a tenth concept which is a rack configured to store at least one knife, the rack comprising an A-frame structure, at least one peg or other device configured to hold at least said knife against gravitational force, and a blade guard situated lower on the A-frame than the at least one peg or other device.

The invention also includes an eleventh concept which is the rack of the tenth concept wherein the at least one peg or other device has a distal end bent upwards, and wherein a portion of the distal end that is bent upwards has a length sufficient to prevent or inhibit the at least said knife from scraping against the blade guard.

The invention also includes a twelfth concept which is the rack of the tenth concept, wherein said at least one peg are substantially arranged along a horizontal peg line, and wherein said blade guard is arranged in a slanted linear configuration so that one end of the blade guard is closer to the horizontal peg line than another end of the blade guard.

The invention includes a thirteenth concept which is a knife comprising a means for cutting, a first means for holding that is substantially U-shaped and is attached at only one end of the first means for holding to the means for cutting, and a second means for holding attached at only one end of the second means for holding to the means for cutting, wherein the first means for holding and the second means for holding are substantially parallel elements.

The invention also includes a fourteenth concept which is the knife of the thirteenth concept wherein the first means for holding and the second means for holding are unconnected except via the means for cutting.

The invention also includes a fifteenth concept which is the knife of the thirteenth concept wherein the first means for holding has a means for attaching to the blade, and the second means for holding has a second means for attaching to the blade, and wherein the first means for holding is shaped substantially identically to the second means for holding, at least apart from the first means for attaching and the second means for attaching.

The tangless, two-piece handle design of the present invention represents a fundamentally new way of thinking about the basic structure of knife construction. In one embodiment, the swaged area of the handle is riveted to the spine of the blade. The swage provides a larger bearing surface for the palm to rest on when using the knife (e.g. a chef's knife or utility knife) for slicing and chopping, thereby significantly increasing user comfort. The swage also provides an area against which the thumb or fingers may be braced when using a knife according to the present invention (e.g. a paring knife or boning knife) thereby increasing the user's control, and sense of security.

In this embodiment, each handle consists of a pair of wire forms that flex independently of each other during use. This handle movement provides a shock-absorbing effect, and therefore can potentially reduce repetitive stress associated with Carpal Tunnel Syndrome. The handle has an open form, as opposed to a traditional solid handle. This configuration not only has an attractive appearance, but also has a unique and appealing feeling when held in the user's hand. This knife provides the user with a pleasant tactile experience, and the open handle form offers the innovative storage option of hanging the knives from a peg, in addition to the possibility of using traditional block storage. Hanging the knives has the advantages of immediate identification, and also allows full air circulation around the knife to discourage bacteria.

It is to be understood that the present figures, and the accompanying narrative discussions of best mode embodiments, do not purport to be completely rigorous treatments of the knife blade, A-shaped knife rack, or U-shaped handle forms under consideration. A person skilled in the art will understand that the various structures described in this application can be implemented by a variety of different sequences and configurations, using various different combinations of materials which need not be further detailed herein.

What is claimed is:

1. A knife comprising:
a blade;
a first wire form that is substantially U-shaped and is attached at only one end of the first wire form to the blade; and
a second wire form attached at only one end of the second wire form to the blade,
wherein the first wire form and the second wire form are substantially parallel elements of a single handle.

2. The knife of claim 1 wherein the first wire form and the second wire form are unconnected except via the blade.

3. The knife of claim 1,
wherein the first wire form has a first swaged portion, and the second wire form has a second swaged portion,
wherein the first swaged portion and the second swaged portion are configured to attach to the blade, and
wherein the first wire form is shaped substantially identically to the second wire form, at least apart from the first swaged portion and the second swaged portion.

4. The knife of claim 1,
wherein the blade is tangless,
wherein the blade, the first wire form, and the second wire form include a plurality of holes arranged to attach the first wire form and the second wire form to the blade, and
wherein the holes are arranged so that the first wire form and the second wire form each attach in a substantially flush position with respect to a spine of the blade.

5. A system comprising
the knife of claim 1; and
a rack configured to store at least said knife, the rack comprising an A-frame structure, at least one peg or other device configured to hold at least said knife against gravitational force, and a blade guard situated lower on the A-frame than the at least one peg or other device.

6. The system of claim 5, wherein the at least one peg or other device has a distal end that is bent upward, and wherein a portion of the distal end that is bent upwards has a length sufficient to prevent or inhibit the at least said knife from scraping against the blade guard.

7. The system of claim 5, further comprising a plurality of knives having different sizes, wherein said blade guard is arranged to secure at least part of each of said knives.

8. The system of claim 7, wherein said at least one peg are substantially arranged along a horizontal peg line, and wherein said blade guard is arranged in a slanted linear configuration, so that one end of the blade guard is closer to the horizontal peg line than another end of the blade guard.

9. A wire form that is substantially U-shaped and comprises only one end configured to be attached to a knife blade, wherein the wire form has a swaged portion configured to attach to the blade.

10. A rack configured to store at least one knife, the rack comprising:
an A-frame structure;
at least one peg or other device configured to hold at least said knife against gravitational force; and
a blade guard situated lower on the A-frame than the at least one peg or other device.

11. The rack of claim 10, wherein the at least one peg or other device has a distal end bent upwards, and wherein a portion of the distal end that is bent upwards has a length sufficient to prevent or inhibit the at least said knife from scraping against the blade guard.

12. The rack of claim 10,
wherein said at least one peg are substantially arranged along a horizontal peg line, and
wherein said blade guard is arranged in a slanted linear configuration so that one end of the blade guard is closer to the horizontal peg line than another end of the blade guard.

13. A knife comprising:
a means for cutting;
a first means for holding that is substantially U-shaped and is attached at only one end of the first means for holding to the means for cutting; and
a second means for holding attached at only one end of the second means for holding to the means for cutting,
wherein the first means for holding and the second means for holding are substantially parallel elements.

14. The knife of claim 13, wherein the first means for holding and the second means for holding are unconnected except via the means for cutting.

15. The knife of claim 13,
wherein the first means for holding has a means for attaching to the blade, and the second means for holding has a second means for attaching to the blade, and
wherein the first means for holding is shaped substantially identically to the second means for holding, at least apart from the first means for attaching and the second means for attaching.

16. A system comprising:
the knife of claim 1; and
a block configured to accept said knife by inserting said blade into said block, and to accept a plurality of other knives.
